(19) United States
(12) Patent Application Publication
(10) Pub. No.: US 2026/0273814 A1
(43) Pub. Date: Sep. 17, 2026

(54) SYSTEMS AND METHODS FOR MANUFACTURING VENT FRAMES WITH INTEGRATED SCREENS

(71) Applicant: MASTIC HOME EXTERIORS, INC., Cary, NC (US)

(72) Inventors: Andy BREUER, Cary, NC (US); Stan SAK, Cary, NC (US); Zach DUGGAN, Cary, NC (US); Kaleb HAHN, Cary, NC (US)

(21) Appl. No.: 19/076,707

(22) Filed: Mar. 11, 2025

(51) Int. Cl. B29C 45/14; B29L 12/00; F24F 13/08

(52) U.S. Cl. CPC B29C 45/14008; F24F 13/08; B29L 2012/00

(57) ABSTRACT

Systems and methods for manufacturing vent frames with integrated screen are disclosed. A method may include: providing a lower portion of a mold for a frame to a machine, the lower portion of the mold having an opening; providing a screen for the frame over the opening in the lower portion of the mold and temporarily holding the screen in place; providing an upper portion of the mold over the lower portion of the mold and the screen; injecting a hot material into the mold; separating the upper portion of the mold from the lower portion of the mold; and removing the frame from the mold, wherein the screen is integrated into the frame.

### BACKGROUND OF THE INVENTION

### 1. Field of the Invention

Embodiments are generally directed to systems and methods for manufacturing vent frames with integrated screen.

### 2. Description of the Related Art

Manufacturing a vent frame with a screen, such as gable vent with an insect screen, is a multi-cycle process in which an insect screen is place on a frame and then welded in place. Often, a cover is added over the weld for aesthetics. Thus, multiple interactions with hot materials are involved, leading to a potential safety risk.

### SUMMARY OF THE INVENTION

Systems and methods for manufacturing vent frames with integrated screen are disclosed. In one embodiment, a method may include: providing a lower portion of a mold for a frame to a machine, the lower portion of the mold having an opening; providing a screen for the frame over the opening in the lower portion of the mold and temporarily holding the screen in place; providing an upper portion of the mold over the lower portion of the mold and the screen; injecting a hot material into the mold; separating the upper portion of the mold from the lower portion of the mold; and removing the frame from the mold, wherein the screen is integrated into the frame.

In one embodiment, the frame is for a gable vent.

In one embodiment, the frame is for a window.

In one embodiment, the machine comprises an injection molding machine.

In one embodiment, the hot material comprises a plastic.

In one embodiment, the screen comprises an insect screen.

In one embodiment, the screen is temporarily held in place using suction.

In one embodiment, the frame is removed from the mold using the suction.

In one embodiment, the method may also include releasing the screen after the hot material is injected into the mold.

In one embodiment, the method may also include releasing the screen after the hot material has hardened.

According to another embodiment, a frame may be made by a process including: providing a lower portion of a mold for the frame to a machine, the lower portion of the mold having an opening; providing a screen for the frame over the opening in the lower portion of the mold and temporarily holding the screen in place; providing an upper portion of the mold over the lower portion of the mold and the screen; injecting a hot material into the mold; separating the upper portion of the mold from the lower portion of the mold; and removing the frame from the mold, wherein the screen is integrated into the frame.

In one embodiment, the frame is for a gable vent.

In one embodiment, the frame is for a window.

In one embodiment, the machine comprises an injection molding machine.

In one embodiment, the hot material comprises a plastic.

In one embodiment, the screen comprises an insect screen.

In one embodiment, the screen is temporarily held in place using suction.

In one embodiment, the frame is removed from the mold using the suction.

In one embodiment, the process may also include releasing the screen after the hot material is injected into the mold.

In one embodiment, the process may also include releasing the screen after the hot material has hardened.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a method for manufacturing vent frames with integrated screen according to an embodiment;

FIG. 2 depicts a vent frame with an integrated screen according to an embodiment.

### DETAILED DESCRIPTION OF PREFERRED EMBODIMENTS

Systems and methods for manufacturing vent frames with integrated screen are disclosed.

It should be noted that, although embodiments refer to gable vents and insect screens, the disclosure is not so limited, and other types of frames with openings, and other types of screens, are within the scope of this disclosure.

Embodiments significantly reduce the cost of molding the parts by eliminating a secondary welding attachment process of the insect screen, as well improving the overall quality and aesthetics of the assembly, and making the production of the components safer by reducing cycle operations and reducing interaction with melted plastic.

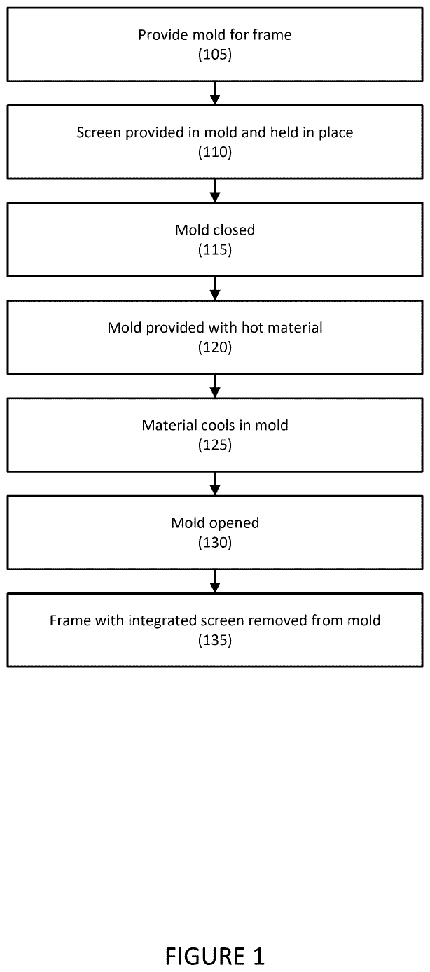

Referring to FIG. 1, a method for manufacturing vent frames with integrated screens is disclosed according to an embodiment.

In step 105, a mold for a frame may be provided. In one embodiment, the mold may be for a frame of a gable vent, and may include an opening. Any suitable mold may used, and the mold may be provided to an injection molding machine.

In one embodiment, the mold may have an upper portion and a lower portion, and the lower portion may be provided to the injection molding machine.

In step 110, a screen may be provided to the mold and may be temporarily held in place. For example, a screen, such as an insect screen, may be placed manually or by a machine over the opening in the lower portion of the mold. The screen may be held in place using, for example, suction provided by a vacuum, pressure, magnetic force, etc.

In step 115, the mold may be closed. For example, if provided on an injection molding machine, the mold may include an opening for receiving a frame material, such a hot plastic. An example of a suitable plastic is polypropylene.

In another embodiment, an upper portion of the mold may be provided on the lower portion of the mold, with the screen held in place over the opening, and the hot material may be injected into an opening in the mold.

In step 120, the mold may be provided with the hot material via the opening. In one embodiment, the frame may remain in place due to the suction.

One the hot material has been injected, or after the hot material has sufficiently hardened, the screen may optionally be released. For example, the suction may be removed or released from the screen.

In step 125, the hot material may cool in the mold. As the hot material cools, it will harden, and the screen will be integrated into the frame.

In step 130, after an appropriate period, the mold may be opened, or the top portion may be removed from the lower portion, and in step 135, the frame with the integrated screen may be injected. For example, if not released, the suction used to hold the screen in place may be used to remove the frame from the mold.

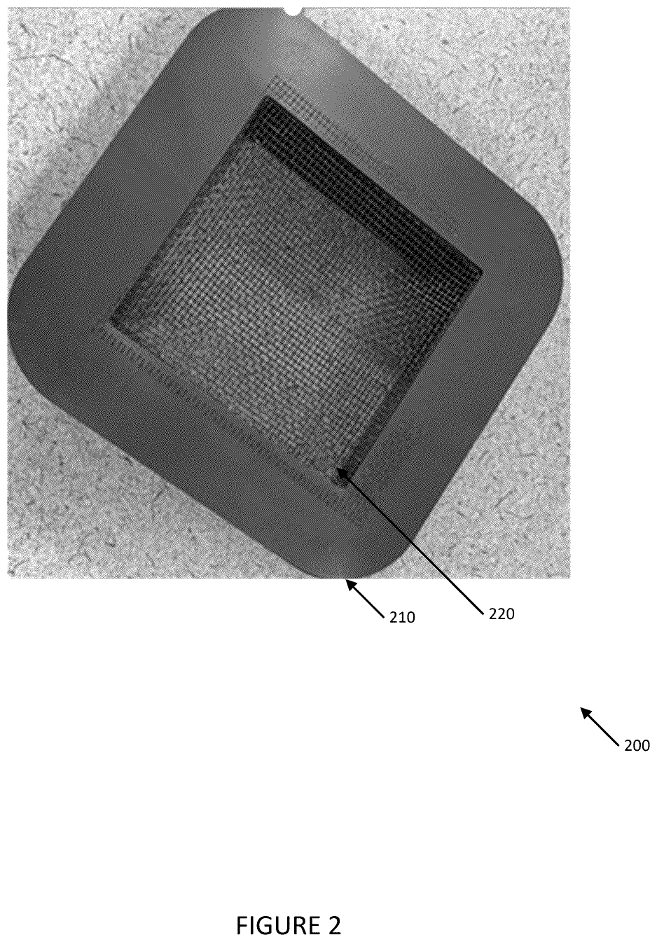

FIG. 2 depicts an assembled vent frame with an integrated screen according to an embodiment. Integrated frame and screen 200 may include frame 210 and screen 220. As illustrated, screen 220 is integrated into frame 210 during the injection and cooling process.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
providing a lower portion of a mold for a frame to a machine, the lower portion of the mold having an opening;
providing a screen for the frame over the opening in the lower portion of the mold and temporarily holding the screen in place;
providing an upper portion of the mold over the lower portion of the mold and the screen;
injecting a hot material into the mold;
separating the upper portion of the mold from the lower portion of the mold; and
removing the frame from the mold, wherein the screen is integrated into the frame.

2. The method of claim 1, wherein the frame is for a gable vent.

3. The method of claim 1, wherein the frame is for a window.

4. The method of claim 1, wherein the machine comprises an injection molding machine.

5. The method of claim 1, wherein the hot material comprises a plastic.

6. The method of claim 1, wherein the screen comprises an insect screen.

7. The method of claim 1, wherein the screen is temporarily held in place using suction.

8. The method of claim 7, wherein the frame is removed from the mold using the suction.

9. The method of claim 1, further comprising:
releasing the screen after the hot material is injected into the mold.

10. The method of claim 1, further comprising:
releasing the screen after the hot material has hardened.

11. A frame made by a process comprising:
providing a lower portion of a mold for the frame to a machine, the lower portion of the mold having an opening;
providing a screen for the frame over the opening in the lower portion of the mold and temporarily holding the screen in place;
providing an upper portion of the mold over the lower portion of the mold and the screen;
injecting a hot material into the mold;
separating the upper portion of the mold from the lower portion of the mold; and
removing the frame from the mold, wherein the screen is integrated into the frame.

12. The frame of claim 11, wherein the frame is for a gable vent.

13. The frame of claim 11, wherein the frame is for a window.

14. The frame of claim 11, wherein the machine comprises an injection molding machine.

15. The frame of claim 11, wherein the hot material comprises a plastic.

16. The frame of claim 11, wherein the screen comprises an insect screen.

17. The frame of claim 11, wherein the screen is temporarily held in place using suction.

18. The frame of claim 17, wherein the frame is removed from the mold using the suction.

19. The frame of claim 11, the process further comprising:
releasing the screen after the hot material is injected into the mold.

20. The frame of claim 11, the process further comprising:
releasing the screen after the hot material has hardened.
